(19) United States
(12) Patent Application Publication
(10) Pub. No.: US 2024/0150592 A1
(43) Pub. Date: May 9, 2024

(54) PHOTOCURABLE CONDUCTIVE BLACK COMPOSITION AND A METHOD FOR FORMING A CURED PRODUCT THEREOF

(71) Applicant: DuPont Electronics, Inc., Wilmington, DE (US)

(72) Inventors: Chien-Ho HUANG, HSINCHU (TW); Yi-Ting CHEN, HSINCHU (TW); Tsung-Han TSAI, HSINCHU (TW); Li-Yen LIN, HSINCHU (TW)

(21) Appl. No.: 18/493,047

(22) Filed: Oct. 24, 2023

Related U.S. Application Data
(60) Provisional application No. 63/422,374, filed on Nov. 3, 2022.

(51) Int. Cl. C09D 5/24; C08F 220/18; C08F 222/10; C08K 13/04; C08K 13/06; C09D 4/00; C09D 7/40; C09D 7/41; C09D 7/62; C09D 133/06; C09D 135/02; H01B 1/12

(52) U.S. Cl. CPC C09D 5/24; C08F 220/1811; C08F 222/102; C08K 13/04; C08K 13/06; C09D 4/00; C09D 7/41; C09D 7/62; C09D 7/70; C09D 133/062; C09D 135/02; H01B 1/12; C08F 2800/20; C08K 9/04; C08K 2201/001; C08K 2201/011

(57) ABSTRACT

Provided is a photocurable conductive black composition including: (a) at least one (meth)acrylate-functionalized urethane oligomer; (b) at least one photopolymerizable compound; (c) a photoinitiator; (d) a visible-light blocking system; (e) conductive fillers; and optionally (f) a thermal initiator.

Also provided are a method for forming a cured product composed of the photocurable conductive black compositions, and an article comprising the cured product.

### FIELD OF THE INVENTION

The present invention relates to a photocurable conductive black composition, a method for forming a cured product thereof, and an article comprising the cured product.

### BACKGROUND OF THE INVENTION

In recent years, conductive compositions are widely used for electronic components/devices with grounding, electromagnetic interference (EMI) shielding, and thermal management needs such as heaters, display panels, and sensors. U.S. Pat. No. 8,193,707 B2 discloses a black conductive composition for bus electrodes to improve the contrast of plasma display panels. Because the black conductive composition blocks visible light leakage into image sensor behind display panel, it may also reduce electrical signal interference. The demand of black color in some display or electronic devices, including monitor and mobile phone, is also gradually increasing.

To block the visible light, black dyes, mixture of dyes, black pigments or carbon black were applied into adhesive resins. Conversional curing mechanism for conductive composition is thermal cured. JP7070061B2 discloses a conductive composition comprised urethane base resins, crosslinking agent, and conductive fillers. After applying the composition onto assigned area of component, thermal treatment (150° C. for 60 mins) is utilized to fully cure the composition. Thermal curing mechanism require long curing time, so low productivity is a disadvantage. Moreover, thermal treatment cannot be applied to electronic component/devices which may be thermally degradable. Relatively speaking, the photo-curing mechanism takes only a few seconds to achieve complete crosslinked. Therefore, there is thus a need to produce a photocurable conductive black compositions that could cure in few minutes and increase the productivity.

### SUMMARY OF THE INVENTION

In view of the foregoing, the present invention provides a photocurable conductive black composition comprising:
(a) 10-90 parts by weight of at least one (meth)acrylate-functionalized urethane oligomer;
(b) 90-10 parts by weight of at least one polymerizable compound;
(c) 0.1-10 parts by weight of a photoinitiator;
(d) 0.1-10 parts by weight of a visible-light blocking system; and
(e) 0.1-10 parts by weight of conductive fillers;

wherein
the total amount of the (meth)acrylate-functionalized urethane oligomer of component (a) and the polymerizable compound of component (b) is 100 parts by weight;
the amounts of component (c), component (d) and component (e) are based on the total amount of the (meth)acrylate-functionalized urethane oligomer of component (a) and the polymerizable compound of component (b) being 100 parts by weight; and
the photocurable conductive black composition has an average optical density in the visible-light region from 400 nm to 700 nm, referred as OD_{AVG}, being 1.0 or more; an optical density at the wavelength of 365 nm, referred as OD₃₆₅, being 1.9 or less; and the optical density data are obtained by measuring a 30 μm thick cured film composed of the photocurable conductive black composition by a UV-VIS absorption spectroscopy.

Also, the present invention provides a method for forming a cured product composed of the photocurable conductive black composition of the present invention, comprising:
i) providing a substrate;
ii) applying the photocurable conductive black composition of the present invention to the substrate;
iii) curing by irradiating light rays in a wavelength region of from 300 nm to 400 nm using a light source to obtain a substrate having a cured product of the photocurable conductive black composition of the present invention; and
iv) optionally, heating the substrate having the cured product of step (iii);

wherein
the substrate is a component of an article; and
the article is an entertainment device, a mobile device, or an electronic device.

The present invention further provides an article comprising a cured product composed of the photocurable conductive black composition, wherein the article is an entertainment device, a mobile device, or an electronic device.

### DETAILS OF THE INVENTION

The following examples are used to exemplify the present invention. A person of ordinary skill in the art can conceive the other advantages and effects of the present invention, based on the disclosure of the specification. The present invention can also be implemented or applied as described in different examples. It is possible to modify and/or alter the examples for carrying out this disclosure without contravening its scope, for different aspects and applications.

It is further noted that, as used in this disclosure, the singular forms “a,” “an,” and “the” include plural referents unless expressly and unequivocally limited to one referent. The term “or” is used interchangeably with the term “and/or” unless the context clearly indicates otherwise.

All publications, patent applications, patents and other references mentioned herein, if not otherwise indicated, are explicitly incorporated by reference herein in their entirety for all purposes as if fully set forth.

Unless otherwise defined, all technical and scientific terms used herein have the same meaning as commonly understood by one of ordinary skill in the art to which this invention belongs. In case of conflict, the present specification, including definitions, will control.

Unless stated otherwise, all percentages, parts, ratios, etc., are by weight.

As used herein, the terms “comprises,” “comprising,” “includes,” “including,” “has,” “having,” “contains” or “containing,” or any other variation thereof, are intended to cover a non-exclusive inclusion. For example, a composition, process, method, article, or apparatus that comprises a list of elements is not necessarily limited to only those elements but may include other elements not expressly listed or inherent to such composition, process, method, article, or apparatus. Moreover, the term “comprising” is intended to include embodiments encompassed by the terms “consisting essentially of” and “consisting of”. Similarly, the term “consisting essentially of” is intended to include embodiments encompassed by the term “consisting of”.

The transitional phrase “consisting of” excludes any element, step, or ingredient not specified. If in the claim, such a phrase would close the claim to the inclusion of materials other than those recited except for impurities ordinarily associated therewith. When the phrase “consisting of” appears in a clause of the body of a claim, rather than immediately following the preamble, it limits only the element set forth in that clause; other elements are not excluded from the claim as a whole.

When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. For example, when a range of “10 to 90” is recited, the recited range should be construed as including ranges “10 to 80”, “10 to 50”, “20-90”, “10 to 60 & 80 to 90”, “10 to 60 & 80”, and the like. Where a range of numerical values is recited herein, unless otherwise stated, the range is intended to include the endpoints thereof, and all integers and fractions within the range.

When the term “about” is used in describing a value or an end-point of a range, the disclosure should be understood to include the specific value or end-point referred to. As used herein, the term “about” generally means within 10%, 5%, 1%, or 0.5% of a given value or range. Alternatively, the term “about” means within an acceptable standard error of the mean when considered by one of ordinary skill in the art. Unless otherwise expressly specified, all of the numerical ranges, amounts, values and percentages such as those for quantities of materials, durations of time periods, temperatures, operating conditions, ratios of amounts, and the likes disclosed herein should be understood as modified in all instances by the term “about.”

The term “(meth)acrylate” is used generally to include derivatives of acrylic acid and methacrylic acid, including acrylate and methacrylate, unless clearly indicated otherwise. The term “alkyl (meth)acrylate” is therefore intended to include substituted as well as unsubstituted alkyl ester of a (meth)acrylic acid with the alkyl group having from about 1 carbon atom to about 8 carbon atoms. Similarly, the term “di(meth)acrylate” means diacrylic acid and dimethacrylic acid, including diacrylate or a dimethacrylate, and the term “poly(meth)acrylate” means polyacrylic acid and polymethacrylic acid, including polyacrylate or a polymethacrylate. The “(meth)acrylate” as used herein means a compound having one (meth)acryloxy group, the term “di(meth)acrylate” as used herein means a compound having two (meth)acryloxy groups, and similarly, the term “poly(meth)acrylate” as used herein means a compound having more (meth)acryloxy groups than “(meth)acrylate” and “di(meth)acrylate”. For example, “poly(meth)acrylate” comprises tri(meth)acrylate, tetra(meth)acrylate, penta(meth)acrylate, hexa(meth)acrylate, and higher functionality (meth)acrylate.

The term “oligomer” refers to a molecule comprising a few monomer residues (repeating units) connected by covalent chemical bonds, and the concept of “oligomer” is contrasted to that of a “polymer”, which is usually understood to have a large number of units, possibly thousands or millions. Non-limiting examples of oligomers include one or more types of monomers.

The term “photocurable” refers to a property of a material that can undergo a chemical reaction or physical action initiated by light, resulting in a harder, tougher, or more stable linkage or substance, i.e., cured product. In polymer chemistry, “curing” specifically refers to the toughening or hardening of a polymer via cross-linking of polymer chains.

The term “light blocking” refers to mitigating the transmittance of light, and “visible-light blocking composition” therefore refers to a composition containing a compound or material that mitigating the transmittance of visible-light.

The term “average functionality” refers to the average number of the (meth)acryloxy group in each molecular chain.

The term “optical density” or “OD” is a parameter representing the absorbance of light at a specific wavelength. OD is used when the transmission of light is extremely small for a material. OD is defined as the negative of the logarithm (base 10) of the transmission (T), where transmission is between 0 and 1; OD=−log₁₀(T).

Embodiments of the present invention include any embodiments described herein, may be combined in any manner, and the descriptions of variables in the embodiments pertain not only to the photocurable conductive black composition of the present invention, but also to the cured product thereof.

The invention is described in detail herein under.

### Photocurable Conductive Black Composition

The present invention is directed to a photocurable conductive black composition comprising:
(a) 10-90 parts by weight of at least one (meth)acrylate-functionalized urethane oligomer;
(b) 90-10 parts by weight of at least one polymerizable compound;
(c) 0.1-10 parts by weight of a photoinitiator;
(d) 0.1-10 parts by weight of a visible-light blocking system; and
(e) 0.1-10 parts by weight of conductive fillers;

wherein
the total amount of the (meth)acrylate-functionalized urethane oligomer of component (a) and the polymerizable compound of component (b) is 100 parts by weight;
the amounts of component (c), component (d) and component (e) are based on the total amount of the (meth)acrylate-functionalized urethane oligomer of component (a) and the polymerizable compound of component (b) being 100 parts by weight.

In at least one embodiment of the present invention, a cured film composed of the photocurable conductive black composition has an average optical density (OD_{AVG}) of 1.0 or more in the wavelength region from 400 nm to 700 nm, and an optical density (OD₃₆₅) of 1.9 or less at the wavelength of 365 nm as measured by a UV-VIS absorption spectroscopy.

In some embodiments, a cured film composed of the present composition with a thickness of about 30 μm has an OD_{AVG} of 1.0 or more, or 1.5 or more, or 2.0 or more, or 2.4 or more.

In some embodiments, a cured film composed of the present composition with a thickness of about 30 μm has an OD₃₆₅ of 1.9 or less, or 1.75 or less, or 1.5 or lessor 1.25 or less.

In some embodiments, the cured film composed of the present composition with a thickness of about 30 μm has a ratio of the OD_{AVG} to the OD₃₆₅ measured by a UV-VIS absorption spectroscopy is 1.0 or more, or about 1.2 or more, or about 1.3 or more.

### (a) (Meth)Acrylate-Functionalized Urethane Oligomer

In the present composition, the (meth)acrylate-functionalized urethane oligomer of component (a) has an average (meth)acrylate functionality of two or more per molecule.

In some embodiments, the (meth)acrylate-functionalized urethane oligomer of component (a) has an average functionality of the (meth)acryloxy group of more than two to up to six per molecule, for example, the average functionality of the (meth)acryloxy group per molecule is 2, 3, 4, 5, or 6, but not limited thereto.

In at least one embodiment, the (meth)acrylate-functionalized urethane oligomer of component (a) has a viscosity at 60° C. in a range of about 5,000 to about 40,000 mPa*s, or about 7,500 to about 30,000 mPa·s, or about 10,000 to about 20,000 mPa·s.

In one embodiment, the (meth)acrylate-functionalized urethane oligomer of component (a) has a viscosity at 60° C. in a range of about 5,000 to about 400,000 mPa*s, or about 7,500 to about 380,000 mPa·s, or about 10,000 to about 350,000 mPa·s.

In another embodiment, the (meth)acrylate-functionalized urethane oligomer of component (a) has a viscosity at 25° C. in a range of about 10,000 to about 40,000 mPa·s, or about 12,500 to about 35,000 mPa·s, or about 15,000 to about 30,000 mPa·s.

In yet another embodiment, the (meth)acrylate-functionalized urethane oligomer of component (a) has a viscosity at 25° C. in a range of about 10,000 to about 400,000 mPa·s, or about 12,500 to about 380,000 mPa·s, or about 15,000 to about 350,000 mPa·s.

In some embodiments, the viscosity refers to the Brookfield viscosity that is measured with spindle No. 27 and a rotation speed of 1-30 rpm(s).

In at least one embodiment, the (meth)acrylate-functionalized urethane oligomer of component (a) has an oligomeric backbone which is a reaction product of at least one diisocyanate and at least one polyalkylene glycol (PAG).

In some embodiments, the diisocyanate can be selected from the group consisting of toluene diisocyanate (TDI), isophorone diisocyanate (IPDI), methylene diphenyl diisocyanate (MDI), dicyclohexylmethane diisocyanate (HMDI), hexamethylene diisocyanate (HDI), trimethylhexamethylene diisocyanate, (TMDI), xylylene diisocyanate (XDI), lysine diisocyanate (LDI), and a combination thereof. In another embodiment, the diisocyanate is isophorone diisocyanate (IPDI), methylene diphenyl diisocyanate (MDI), or dicyclohexylmethane diisocyanate (HMDI).

In some embodiments, the polyalkylene glycol can be selected from the group consisting of polyethylene glycols, polypropylene glycols, polybutylene glycols, and a combination thereof. Noted that polypropylene glycols include 1,2-polypropylene diol and 1,3-polypropylene diol; butylene glycols include 1,2-butanediol, 1,3-butanediol, 1,4-butanediol and 2,3-butanediol.

In at least one embodiment, based on the total amount of the (meth)acrylate-functionalized urethane oligomer of component (a) and the polymerizable compound of component (b), the amount of the (meth)acrylate-functionalized urethane oligomer of component (a) in the present composition is 10-90 parts by weight, or 20-80 parts by weight, or 30-70 parts by weight, or 40-60 parts by weight.

### (b) Polymerizable Compound

In the present composition, the polymerizable compound of component (b) comprises at least one reactive ethylenic unsaturated bond and has a molecular weight less than 3,000.

In some embodiments, the polymerizable compound of component (b) has at least one reactive ethylenic unsaturated bond that can undergo a chemical reaction with the (meth)acrylate-functionalized urethane oligomer of component (a) when the photocurable composition of the present invention is subjected to a light irradiation.

In at least one embodiment, the polymerizable compound of component (b) comprises at least one (meth)acrylate functional group and has a molecular weight less than 3,000.

In another embodiment, the polymerizable compound of component (b) comprises a (meth)acrylate compound, a di(meth)acrylate compound, a poly(meth)acrylate compound, or a mixture thereof.

In at least one embodiment, the polymerizable compound of component (b) can be a (meth)acrylate compound selected from the group consisting of butyl (meth)acrylate, 2-ethylhexyl (meth)acrylate, isooctyl (meth)acrylate, 2-propylheptyl (meth)acrylate, isodecyl (meth)acrylate, lauryl (meth)acrylate, tridecyl (meth)acrylate, stearyl (meth)acrylate, behenyl (meth)acrylate, cyclohexyl (meth)acrylate, tetrahydrofurfuryl (meth)acrylate, cyclic trimethylolpropane formal (meth)acrylate, isobornyl (meth)acrylate, dicyclopentadienyl (meth)acrylate, dihydrodicyclopentadienyl (meth)acrylate, dicyclopentenyloxyethyl (meth)acrylate, benzyl (meth)acrylate, 2-phenoxyethyl (meth)acrylate, (o-phenylphenoxy)ethyl (meth)acrylate, nonylphenol (meth)acrylate, 9-anthracenyl methyl (meth)acrylate, 1-pyrenylmethyl (meth)acrylate, 2-ethoxyethyl (meth)acrylate, 2-(2-methoxyethoxy)ethyl (meth)acrylate, 2-(2-ethoxyethoxy)ethyl (meth)acrylate, triethylene glycol methyl ether (meth)acrylate, polyethylene glycol methyl ether (meth)acrylate, tripropylene glycol methyl ether (meth)acrylate, ethoxylated phenol (meth)acrylate, ethoxylated nonylphenol (meth)acrylate, ethoxylated neopentyl glycol mono(meth)acrylate, propoxylated neopentyl glycol mono(meth)acrylate, caprolactone (meth)acrylate, 2-(meth)acryloyloxyethyl succinate, 2-(acetoacetoxy)ethyl (meth)acrylate, 2-(phosphonooxy)ethyl (meth)acrylate, 3-(phosphonooxy)propyl (meth)acrylate, 2-(2-phosphonooxyethoxy)ethyl (meth)acrylate, 5-(phosphonooxy)pentyl (meth)acrylate, 6-(phosphonooxy)hexyl (meth)acrylate, 2-[(hydroxymethoxyphosphinyl)oxy]ethyl (meth)acrylate, 2-[(ethoxyhydroxyphosphinyl)oxy]ethyl (meth)acrylate, 2-[(hydroxypropoxy-phosphinyl)oxy]ethyl (meth)acrylate, and a combination thereof.

In at least one embodiment, the polymerizable compound of component (b) can be a di(meth)acrylate compound selected from the group consisting of 1,2-ethanediol di(meth)acrylate, 1,3-butanediol di(meth)acrylate, 1,4-butanediol di(meth)acrylate, 1,6-hexanediol di(meth)acrylate, 1,8-octanediol di(meth)acrylate, 1,9-nonanediol di(meth)acrylate, 1,10-decanediol di(meth)acrylate, polybutadiene di(meth)acrylate, polytetramethylene glycol di(meth)acrylate, propylene glycol di(meth)acrylate, neopentyl glycol di(meth)acrylate, diethylene glycol di(meth)acrylate, triethylene glycol di(meth)acrylate, tetraethylene glycol di(meth)acrylate, polyethylene glycol di(meth)acrylate, dipropylene glycol di(meth)acrylate, tripropylene glycol di(meth)acrylate, tetrapropylene glycol di(meth)acrylate, polypropylene glycol di(meth)acrylate, glycerol 1,3-di(meth)acrylate, ethoxylated glyceryl di(meth)acrylate, propoxylated glyceryl di(meth)acrylate, tricyclodecanedimethanol di(meth)acrylate, neopentyl glycol di(meth)acrylate, ethoxylated neopentyl glycol ethoxylate di(meth)acrylate, propoxylated neopentyl glycol di(meth)acrylate, ethoxylated bisphenol A di(meth)acrylate, propoxylated bisphenol A di(meth)acrylate, ethoxylated propoxylated bisphenol A di(meth)acrylate, methacryloyloxyethyl phosphate, bis[2-((meth)acryloyloxy)ethyl] phosphate, and a combination thereof.

In at least one embodiment, the polymerizable compound of component (b) can be a poly(meth)acrylate compound selected from the group consisting of trimethylolpropane tri(meth)acrylate, ethoxylated trimethylolpropane tri(meth)acrylate, propoxylated trimethylolpropane tri(meth)acrylate, glycerin tri(meth)acrylate, ethoxylated glyceryl tri(meth)acrylate, propoxylated glyceryl tri(meth)acrylate, pentaerythritol tri(meth)acrylate, tris(2-hydroxyethyl) isocyanurate tri(meth)acrylate, pentaerythritol tetra(meth)acrylate, ethoxylated pentaerythritol tetra(meth)acrylate, propoxylated pentaerythritol tetra(meth)acrylate, ditrimethylolpropane tetra(meth)acrylate, ethoxylated ditrimethylolpropane tetra(meth)acrylate, propoxylated ditrimethylol-propane tetra(meth)acrylate, dipentaerythritol penta(meth)acrylate, ethoxylated dipentaerythritol penta(meth)acrylate, dipentaerythritol hexa(meth)acrylate, and a combination thereof.

In at least one embodiment, based on the total amount of the (meth)acrylate-functionalized urethane oligomer of component (a) and the polymerizable compound of component (b), the amount of the polymerizable compound of component (b) in the present composition is 10-90 parts by weight, or 20-80 parts by weight, or 30-70 parts by weight, or 40-60 parts by weight.

The polymerizable compound of component (b) also can be used to adjust the viscosity and the adhesion property of the present composition since the above-mentioned compounds are generally known as having a low viscosity at normal temperature.

In at least one embodiment, the ratio between the amounts of the (meth)acrylate-functionalized urethane oligomer of component (a) and the polymerizable compound of component (b) is in a range of 10:90 to 90:10, for example, 10:90, 20:80, 30:70, 40:60, 50:50, 60:40, 70:30, 80:20, or 90:10. For instance, when the amount of the (meth)acrylate-functionalized urethane oligomer of component (a) is higher than that of the polymerizable compound of component (b), such as the ratio of component (a) to component (b) is 90:10, the present composition would have a higher viscosity; when the amount of the (meth)acrylate-functionalized urethane oligomer of component (a) is lower than that of the polymerizable compound of component (b), such as the ratio of component (a) to component (b) is 10:90, a viscosity of the prepared present composition would be lower.

### (c) Photoinitiator

In the present composition, the photoinitiator of component (c) comprises at least one selected from the group consisting of 2,4,6-trimethylbenzoylethoxyphenylphosphine oxide, phenylbis(2,4,6-trimethylbenzoyl)phosphine oxide, diphenyl(2,4,6-trimethylbenzoyl) phosphine oxide, bis(2,6-di-methoxybenzoyl)(2,4,4-tri-methyl-pentyl)phosphine oxide, 2,2-diethoxyacetophenone, 2,2-dimethoxy-2-phenylacetophenone, 1-hydroxycyclohexyl phenyl ketone, 2-hydroxy-2-methylpropiophenone, 2-hydroxy-4′-(2-hydroxyethoxy)-2-methylpropiophenone, 2-benzyl-2-dimethylamino-4′-morpholinobutyrophenone, 2-methyl-4′-(methylthio)-2-morpholinopropiophenone, benzophenone, benzyl dimethyl ketal, 2-isopropylthioxanthone, and a mixture thereof.

In at least one embodiment, based on the total amount of the (meth)acrylate-functionalized urethane oligomer of component (a) and the polymerizable compound of component (b) being 100 parts by weight, the amount of the photoinitiator of component (c) in the present composition is 0.1-10 parts by weight, or 0.5-7.5 parts by weight, or 1-5 parts by weight.

### (d) Visible-Light Blocking System

In the present composition, suitable substances for use as the visible-light blocking system of component (d) are dyes, pigments, or mixtures thereof. The dyes and pigments can reduce the transmittance of visible-light and have various colors so long as these substances achieve the visible-light blocking function.

In some embodiments, the visible-light blocking system of component (d) used in the present composition are dyes, pigments, or mixtures thereof.

Specifically, dyes and pigments are substances that impart color to a polymeric matrix. The main difference between dyes and pigments is that dyes are soluble, while pigments are insoluble and are suspended in the polymeric matrix. The different solubilities of dyes and pigments are due to the respective particle size difference.

In some embodiments, the dyes can be at least one selected from the group consisting of a dye having a maximum absorption at 452 nm, 473 nm, 525 nm, 637 nm, or 680 nm, or a mixture thereof, but not limited thereto. In some embodiments, the pigment can be for example but not limited to a perylene-based black pigment.

In at least one embodiment, based on the total amount of the (meth)acrylate-functionalized urethane oligomer of component (a) and the polymerizable compound of component (b) being 100 parts by weight, the amount of the visible-light blocking system of component (d) in the present composition is 0.1-10 parts by weight, or 0.5-8 parts by weight, or 1-5 parts by weight, or 1.5-3 parts by weight.

### (e) Conductive Fillers

In the present composition, the conductive fillers of component (e) may be in form of particles, flakes, whiskers, tubes, or wires. The conductive fillers of component (e) may comprise metallic fillers, carbon-based fillers, or a mixture thereof so long as the conductive fillers of component (e) as a whole may provide the desired electrical conductivity.

The metallic fillers suitable for use as the conductive fillers of component (e) comprise at one metal selected from Au, Ag, Cu, and an alloy thereof. In some embodiments, the metallic fillers may be metal-coated fillers that are surface-coated with Au, Ag, or Cu.

The carbon-based fillers suitable for use as the conductive fillers of component (e) comprise carbon black, graphite, graphene, carbon hollow spheres, carbon fibers, carbon nanotubes, or a mixture thereof.

In at least one embodiment, based on the total amount of the (meth)acrylate-functionalized urethane oligomer of component (a) and the polymerizable compound of component (b) being 100 parts by weight, the amount of the conductive filler of component (e) in the present composition is 0.1-10 parts by weight, or 0.3-7.5 parts by weight, or 0.5-5 parts by weight, or 1-3 part by weight.

In at least one embodiment, the photocurable conductive black composition after curing is electrically conductive and has an electrical resistivity of 0.1 MΩ/square or less, or 0.075 MΩ/square or less, or 0.05 MΩ/square or less, or 0.025 MΩ/square or less.

### (f) Thermal Initiator

The photocurable conductive black composition of the present invention may further comprises (f) a thermal initiator. The thermal initiator of component (f) may be an organic peroxide, an azo compound, or a mixture thereof.

Non-limiting examples of suitable thermal initiator (f) includes any of the organic peroxides or azo compounds conventionally employed by those skilled in the art of thermal initiation of polymerization, organic peroxide such as diisobutyl peroxide, di-tert-butyl peroxide, di-tert-hexylperoxide, tert-butyl peroxyacetate, tert-butyl peroxypivalate, tert-butyl peroxy 2-ethylhexanoate, 1,1,3,3-tetramethylbutyl peroxy-2-ethylhexanoate, tert-butyl peroxyneoheptanoate, tert-butyl peroxyneodecanoate, 1,1,3,3-tetramethylbutyl peroxy neodecanoate, cumyl peroxyneodecanoate, di(3,5,5-trimethylhexanoyl)peroxide, dilauroylperoxide, tert-butylperoxy isopropyl carbonate, tert-butylperoxy 2-ethylhexyl carbonate, di-n-propyl peroxydicarbonate, diisopropyl peroxydicarbonate, di-sec-butyl peroxydicarbonate, di(2-ethylhexyl) peroxydicarbonate, di(4-tert-butylcyclohexyl) peroxydicarbonate, tert-butyl peroxybenzoate, tert-hexyl peroxybenzoate, 3,t-butyl cumyl peroxide, benzoyl peroxide, dicumyl peroxide, 2,5-dimethyl-2,5-di(benzoylperoxy)hexane, tert-butyl hydroperoxide, cumene hydroperoxide, 2,2-di(t-butylperoxy)butane, 2,5-dimethyl-2,5-di(t-butylperoxy)hexane, disuccinic acid peroxide; azobisisobutyronitrile, and thermal initiators sold under the trade name VAZO™ by Chemours Company of Wilmington, Del.

In at least one embodiment, based on the total amount of the (meth)acrylate-functionalized urethane oligomer of component (a) and the polymerizable compound of component (b) being 100 parts by weight, the amount of the thermal initiator (f) in the present composition is 0.1-10 parts by weight, or 0.3-7.5 parts by weight, or 0.5-5 parts by weight.

### Cured Product

The present invention further provides a cured product composed of the photocurable conductive black composition of at least one embodiment of the present invention. That is, the present invention provides an article comprising a cured product composed of the photocurable conductive black composition of at least one embodiment of the present invention.

When the article is a mobile device comprising a cured film composed of the photocurable conductive black composition, then the cured film has a thickness ranging from about 30 μm to about 100 μm.

When the article is an entertainment device or an electronic device comprising a cured film composed of the photocurable conductive black composition, then the cured film has a thickness ranging from about 60 μm to about 150 μm.

Furthermore, the present invention provides a method for forming a cured product composed of the photocurable conductive black composition of at least one embodiment of the present invention.

The present method comprising:
i) providing a substrate;
ii) applying the photocurable conductive black composition to the substrate; and
iii) irradiating light rays in a wavelength region of from 300 nm to 400 nm by a light source to obtain a substrate having a cured product of the photocurable conductive black composition; and
iv) optionally, heating the substrate having the cured product of step (iii).

One skilled in the art can easily chose a suitable application method for the present photocurable conductive black composition depending on the specific substrate and viscosity of the present compositions. Suitable application methods include ink jet printing, spraying, rolling, dispensing, pad printing, aerosol jet printing, screen printing, flexographic printing, gravure printing, electrohydrodynamic printing, air pressure printing.

In some embodiments, the cured product is formed on the surface of the substrate. The substrate may be a component of an article. The article may be an entertainment device, a mobile device, or an electronic device.

The entertainment device includes, but not limit to, televisions, video players, music players, computers, tablets, and video game consoles.

The mobile device includes, but not limit to, laptops, smartphones, digital cameras, smartwatches, and earphones.

The electronic device includes, but not limit to, biosensors, radio-frequency identification (RFID) systems, touch switches, digital signages, augmented reality (AR) headsets/glasses, virtual reality (VR) headsets/glasses, mobile device connectors in automobiles such as CarPlay, electric vehicles, automotive radars, antennas, photodetectors, electrochemical sensors, strain sensors, solar cells, and supercapacitors.

In some embodiments of the present method, the light rays irradiated by the light source is in a wavelength region from 300 nm to 400 nm, or from 320 nm to 385 nm, or from 340 nm to 370 nm, but not limited thereto.

Without further elaboration, it is believed that one skilled in the art using the preceding description may utilize the present invention to its fullest extent. The following examples are, therefore, to be construed as merely illustrative, and not limiting of the disclosure in any way whatsoever.

### EXAMPLES

The abbreviation “E” stands for “Example” and “CE” stands for “Comparative Example” is followed by a number indicating in which example the photocurable conductive black composition is prepared. The examples and comparative examples were all prepared and tested in a similar manner.

### Materials

### (a) (Meth)Acrylate-Functionalized Urethane Oligomer

A-1: a urethane oligomer, having a viscosity of 11,000 to 13,000 mPa·s at 60° C., UA-1, purchased from Sartomer Chemical Ltd.
A-2: a urethane oligomer, having a viscosity of 325,000 to 335,000 mPa·s at 60° C., Quick Cure® 7100, purchased from KJ Chemicals Corporation.
A-3: a urethane oligomer includes 35% dilute monomer, having a viscosity of 17,000 to 21,000 mPa·s at 60° C., Quick Cure® 8100, purchased from KJ Chemicals Corporation.

### (b) Polymerizable Compound

B-1: isobornyl acrylate, CAS No. 5888-33-5, iBOA, purchased from DSM.
B-2: tricyclodecanedimethanol diacrylate, CAS No. 42594-17-2, A-DCP, purchased from Shin-Nakamura Chemical Ltd.
B-3: methacryloyloxyethyl phosphate, CAS No. 52628-03-2, P-2M, purchased from Kyoeisha Chemical Co., Ltd.
B-4: ethoxylated bisphenol A dimethacrylate, average 4 EO, CAS No. 41637-38-1, BPE-200, purchased from Shin-Nakamura Chemical Ltd.
B-5: polypropylene glycol dimethacrylate, average 7 PO, CAS No. 25852-49-7, 9PG, purchased from Shin-Nakamura Chemical Ltd.
B-6: polyethylene glycol dimethacrylate, average 9 EO, CAS No. 25852-47-5, 9G, purchased from Shin-Nakamura Chemical Ltd.
B-7: trimethylolpropane ethoxy triacrylate, CAS No. 75577-70-7, TMPEOTA, purchased from Allnex Co.

### (c) Photoinitiator

C-1: 2,4,6-trimethylbenzoylethoxyphenylphosphine oxide, CAS No. 84434-11-7, TPO-L, purchased from Chitec Technology Co., Ltd.
C-2: phenylbis(2,4,6-trimethylbenzoyl)phosphine oxide, CAS No. 162881-26-7, Omnirad 819, purchased from IGM Resins.

### (d) Visible-Light Blocking System

D-1: a dye mixture, the composition is shown below.

| | FDB-005 | FDB-006 | FDG-002 | FDR-002 | VBD | Total |
|---|---|---|---|---|---|---|
| Max. absorption (nm) | 452 | 473 | 525 | 680 | 637 | |
| parts by weight* | 0.10 | 0.30 | 0.25 | 0.45 | 0.50 | 1.60 |

FDB-005, FDB-006, FDG-002 and FDR-002 were purchased from Yamada Chemical Co.
VBD: vital blue dye, purchased from Hangzhou Wenlee Chemical Co. Ltd. *parts by weight of each dye is based on the total amount of components (a) and (b) being 100 parts by weight.
D-2: a perylene black pigment, Spectrasense™ Black L-0086, purchased from BASF.
D′: carbon black, CAS. 1333-86-4, MOGUL® E, purchased from Cabot Corporation.

### (e) Conductive Fillers

CF-1: carbon nanotubes, CNT, outer diameter: 10-20 nm, length: 5-15 mm, TSCNT-C, purchased from Taiwan Carbon Materials Corp.
CF-2: silver nanowires, AgNW, diameter: 25 nm, length: 25 mm, purchased from C3 nano.
CF-3: crosslinked branched carbon nanotubes, CNS, ATHLOS™ purchased from Cabot.

### (f) Thermal Initiator

F-1: tert-butyl peroxy 2-ethylhexanoate, CAS No. 3006-82-4, Luperox® 26, purchased from Arkema Co.

### Preparation of Examples 1-25 and Comparative Examples 1-3

Working examples 1-25 (E1-E25) and comparative examples 1-3 (CE1-CE3) were prepared by the general procedures described below. The preparation steps were conducted under yellow light to avoid unintentional curing. The amounts (parts by weight) of the components (a)-(f) in each example and comparative example were listed in Tables 1-3, and were based on the total amounts of components (a) and (b) being 100 parts by weight. Noted that the preparation steps were modified accordingly for E1 and CE1 since the component (f) or component (d) was excluded from the respective composition E1 or CE1.

Step 1: The (meth)acrylate-functionalized urethane oligomer of component (a), the polymerizable compounds of component (b), and the visible-light blocking system of component (d) consisting of dye mixture and/or pigments were weighted and added into a tank with a mechanical stirrer at room temperature. The mixture of components (a), (b) and (d) was stirred at about 6000 rpm for about 60 minutes.

Step 2: Subsequently, the conductive fillers of component (e) were added to the mixture obtained from Step 1 and kept stirring at about 6000 rpm for about 60 minutes.

Step 3: The mixture obtained from Step 2 was transferred into a polypropylene bottle. The photoinitiator of component (c) and the optional thermal initiator component (f) were added and mixed by a Thinky mixer at 700 rpm for 2 minutes to provide a sticky liquid of about 80 grams.

Step 4: The sticky liquid obtained from Step 3 was filtered using a filter bag to remove particles with a size more than 100 μm.

### Evaluation Methods

Curing time: curing time is defined as the time required for a test piece to reach more than 90% curing conversion, and it was determined by an FT-IR instrument (PerkinElmer Spectrum 100 FT-IR with attenuated total reflection (ATR)).

Each of the prepared compositions in E1-E25 and CE1-CE3 was filled into a mold (2 cm×2 cm×60 μm) to prepare a test piece. There were two test pieces prepared for each example and comparative example.

The curing step was carried out at room temperature for the test pieces of E1-E25 and CE1-CE2. The test pieces were irradiated by using a UV light source at 365 nm with a radiation energy of about 170 mW (i.e., about 10200 mJ/60 sec).

The two test pieces of CE3 were thermally cured at 150° C. since there was no photoinitiator in the composition of CE3.

The curing time of the test pieces of each example and comparative example was recorded and listed in Tables 1-3.
Curing conversion: the evaluation was done by measuring the IR spectra of a test piece composed of a photocurable composition before and after photocuring with the same curing energy.

Each of the prepared compositions in E1-E25 and CE1-CE3 was filled into a mold (2 cm×2 cm×60 μm) to prepare a test piece. There were two test pieces prepared for each example and comparative example.

The test pieces of E1-25 and CE1-CE2 were irradiated by using a UV light source at 365 nm with a radiation energy of about 170 mW (i.e., about 10200 mJ/60 sec.) at room temperature.

Every test piece was measured by an FT-IR instrument (PerkinElmer Spectrum 100 FT-IR with attenuated total reflection (ATR)) before and after curing.

The curing conversion was calculated by the following equation:

Conversion %=(1−A_{after}/A_{before}).

The obtained FT-IR spectrum was normalized based on wavenumber range from 1665 cm⁻¹ to 1775 cm⁻¹. A_{after} or A_{before} was the integrated area based on wavenumber ranging from 780 cm⁻¹ to 830 cm⁻¹ that represents the aliphatic C═C double bonds of the unreacted (meth)acrylate groups.

Evaluation Criteria:
“⊚” represents a curing conversion of more than 90%.
“◯” represents a curing conversion of 80%-90%.
“X” represents the curing conversion of less than 80%.
Electrical resistivity: the electrical resistivity of a cured test coupon was determined by using a Fluke 1507 Insulation Resistance Tester with a test voltage 250V.

The resistivity test coupons of E1-E25 and CE1-CE3 were made by filling into a mold (2 cm×2 cm×60 μm) and curing to more than 90% curing conversion. The curing step was carried out at room temperature. The test pieces were irradiated by using a UV light source with a wavelength at 365 nm and a radiation energy of about 170 mW (i.e., about 10200 mJ/60 sec.). The exposure time of E1-E25 and CE1-CE2 was according to curing time experimental result. The test pieces of CE3 were thermally cured at 150° C. for 1.5 hour.

After getting fully cured sample, drawing two horizontal silver paste (5×2 mm) on the cured composition surface, and the interval between two silver paste is 5 mm. The test coupons were put into 65° C. oven for 1 hour to remove the solvent of silver paste (PE311 conductor paste, purchased from Dupont). The sample were stood for 30 mins at room temperature, then the resistance was measured using a Fluke 1507 Insulation Resistance Tester with a test voltage 250V

Evaluation Criteria:
“⊚” represents an electrical resistivity being less than 0.05 MΩ/sq.
“◯” represents an electrical resistivity being in the range of 0.05-0.1 MΩ/sq.
“X” represents an electrical resistivity being more than 0.1 MΩ/sq.
Optical density test: each of the prepared compositions in E1-E25 and CE1-CE3 was filled into a mold (2 cm×2 cm×30 μm) and then cured more than 90% conversion to prepare a test piece for optical density measurements.

There were two test pieces prepared for each example and comparative example. The test pieces of E1-E25 and CE1-CE2 were cured at room temperature by irradiating with a UV light source at 365 nm and a radiation energy of about 170 mW (i.e., about 10200 mJ/60 sec.). The exposure time of E1-E25 and CE1-CE2 was according to curing time experimental result. The test pieces of CE3 were thermally cured at 150° C. for 1.5 hour.

The optical density of each test piece in the wavelength region between from 200 nm to 800 nm was measured by a UV and visible-light spectrophotometer (PerkinElmer Lambda 35 UV/VIS Spectrometer) and recorded in Tables 1-4. Noted that OD_{AVG} is the average optical density for the wavelength region between 400 nm to 700 nm; OD₃₆₅ is the optical density measured at 365 nm.

TABLE 1

| Component | | CE1 | CE2 | CE3 | E1 | E2 | E3 | E4 | E5 |
|---|---|---|---|---|---|---|---|---|---|
| A-1 | UA-1 | 50 | 50 | 50 | 50 | 50 | 50 | 50 | 50 |
| B-1 | iBOA | 30 | 30 | 30 | 30 | 30 | 30 | 30 | 30 |
| B-2 | A-DCP | 20 | 20 | 20 | 20 | 20 | 20 | 20 | 20 |
| C-1 | TPO-L | 1.0 | 1.0 | | 1.0 | 1.0 | 1.225 | 1.0 | 1.0 |
| C-2 | Omnirad 819 | 0.225 | 0.225 | | 0.225 | 0.225 | | 0.225 | 0.225 |
| D-1 | dye mixture | | | 1.6 | 1.6 | 1.6 | 1.6 | 1.6 | |
| D-2 | L-0086 | | | | | | | 1.0 | 1.0 |
| D’ | carbon black | | 3 | | | | | | |
| CF-1 | CNT | 0.7 | 0.7 | 0.7 | 0.7 | 0.7 | 0.7 | 0.7 | 0.7 |
| F-1 | Luperox ® 26 | | | 1.225 | | 0.2 | | | — |

| | | | | | | | | |
|---|---|---|---|---|---|---|---|---|
| Curing time (seconds) | 30 | 120 | 1.5 hour | 60 | 60 | 60 | 60 | 30 |
| Curing conversion, % | ⊚ | ◯ | X | ⊚ | ⊚ | ⊚ | ⊚ | ⊚ |
| OD_{AVG} | 0.75 | 2.08 | 2.11 | 2.16 | 2.18 | 2.09 | 2.32 | 1.17 |
| OD₃₆₅ | 0.89 | 2.28 | 1.58 | 1.67 | 1.76 | 1.70 | 1.84 | 1.09 |
| OD_{AVG}/OD₃₆₅ | 0.84 | 0.91 | 1.34 | 1.29 | 1.24 | 1.23 | 1.26 | 1.08 |
| Resistivity (MΩ/sq) | ⊚ | ⊚ | ⊚ | ⊚ | ⊚ | ⊚ | ⊚ | ⊚ |

For the data in Table 1, the following is evident.

The photocurable composition of CE1 containing no visible-light blocking system had an OD_{AVG} of 0.75 (i.e., about a transmittance of more than 20% in the visible light range) and could easily reach 90% cured by a UV irradiation at 365 nm in 30 seconds. Due to the presence of 3% of carbon black (i.e., a known black pigment), the black composition of CE2 showed an OD_{AVG} of 2.08 and a OD₃₆₅ of 2.28. Consequently, the curing time of CE2 was lengthened (i.e., 120 seconds) as compared to that of CE1. Examining the curing time of CE3, it clearly illustrates that the photoinitiator of component (c) plays a critical role in the present photocurable conductive black composition. The black composition of CE3 containing a thermal initiator of component (f), it finally reached 90% cured after heating at 150° C. for 1.5 hours.

Examples E1-E4 are embodiments of the present photocurable conductive black compositions that appear as black compositions, and each had an OD_{AVG} value similar to the OD_{AVG} value of CE2 (i.e., about a transmission of less than 1% in the visible light range). However, the black composition of E1-E4 were photocured within a surprising shorter curing time, i.e., only half of CE2's curing time. This may attribute to the designed visible-light blocking system of component (d) used in E1-E4 that imparted the needed “blackness” yet still maintained sufficient amount of transmission at 365 nm, i.e., an OD₃₆₅ being 1.9 or less, so the present compositions of E1-E4 could reach 90% cured in 60 seconds by a UV irradiation at 365 nm.

Example E5, an embodiment of the present composition, had an OD_{AVG} of more than 1.0 to show the needed “blackness”, i.e., about a transmittance of less than 10% in the visible light range. In addition, the black composition of E5 also had an OD₃₆₅ less than that of E1-E4, thus a shorter curing time was expected. Nonetheless, the compositions of Examples E1-E5 each demonstrated that the ratio of the OD_{AVG} to the OD₃₆₅ being 1.0 or more. In contrast, the black composition of CE2 or the clear composition of CE1 each had an OD_{AVG} to the OD₃₆₅ being less than 1.0.

In some embodiments, the cured film of the present invention with a thickness of about 30 μm has an OD_{AVG} of 1.0 or more, or 1.5 or more, or 2.0 or more, or 2.4 or more.

In some embodiments, the cured film of the present invention with a thickness of about 30 μm has an OD₃₆₅ of 1.9 or less, or 1.7 or less, or 1.5 or less.

In some embodiments, the cured film of the present invention with a thickness of about 30 μm has a ratio of the OD_{AVG} to the OD₃₆₅ measured by a UV-VIS absorption spectroscopy is 1.0 or more, or 1.1 or more, or 1.2 or more.

Furthermore, the photocurable black compositions of E1-E5 also exhibited similar electrical conductivity as judged by the similar resistivity measured for CE1-CE2.

TABLE 2

| Component | | E1 | E6 | E7 | E8 | ES | E10 | E11 | E12 | E13 |
|---|---|---|---|---|---|---|---|---|---|---|
| A-1 | UA-1 | 50 | 15 | 15 | 15 | 50 | 50 | 50 | 50 | 80 |
| B-1 | iBOA | 30 | 65 | 65 | 65 | 30 | 30 | 30 | 30 | 20 |
| B-2 | A-DCP | 20 | 20 | 20 | 20 | 20 | 20 | 20 | 20 | |
| C-1 | TPO-L | 1.0 | 1.0 | 1.0 | 1.0 | 1.0 | 1.0 | 1.0 | 1.0 | 1.0 |
| C-2 | Omnirad | 0.225 | 0.225 | 0.225 | 0.225 | 0.225 | 0.225 | 0.225 | 0.225 | 0.225 |
| | 819 | | | | | | | | | |
| D-1 | dye | 1.6 | 1.6 | 1.6 | 1.6 | 1.6 | | | | 1.6 |
| | mixture | | | | | | | | | |
| D-2 | L-0086 | | | | | | 1.0 | 1.0 | 1.0 | |
| CF-1 | CNT | 0.7 | 0.3 | 0.7 | 1.0 | | | | | 0.7 |
| CF-2 | AgNW | | | | | 2.5 | 1.0 | 2.5 | 5.0 | |

| | | | | | | | | | |
|---|---|---|---|---|---|---|---|---|---|
| Curing time (seconds) | 60 | 30 | 60 | 90 | 60 | 30 | 60 | 60 | 60 |
| Curing conversion, % | ⊚ | ⊚ | ⊚ | ◯ | ⊚ | ⊚ | ⊚ | ⊚ | ⊚ |
| OD_{AVG} | 2.16 | 1.81 | 2.13 | 2.51 | 2.03 | 1.18 | 1.57 | 1.75 | 2.11 |
| OD₃₆₅ | 1.67 | 1.31 | 1.68 | 2.05 | 1.57 | 1.08 | 1.42 | 1.55 | 1.71 |
| OD_{AVG}/OD₃₆₅ | 1.29 | 1.39 | 1.26 | 1.22 | 1.29 | 1.08 | 1.11 | 1.13 | 1.23 |
| Resistivity (MΩ/sq) | ⊚ | ◯ | ⊚ | ⊚ | ⊚ | ◯ | ⊚ | ⊚ | ⊚ |

For the data in Table 2, the following is evident.

Examples E6-E13 are also embodiments of the present photocurable conductive black compositions. Comparison between E6, E7 and E8, the amount of the conductive filler showed proportional enhancement in electric conductivity. Similar conclusion may be drawn by comparing the resistivity data of E10-12.

Noted that as the content of conductive fillers increased in E8 as compared to E7, it resulted in less amount of light transmission at 365 nm as judging by its higher OD₃₆₅. Consequently, a longer curing time was observed for the composition of E8 than that for the composition of E7.

Comparison between E1, E6-E8 and E9-E12, the present photocurable conductive black compositions may contain different types of conductive fillers to provide desired electrical conductivity so long as the amount of the conductive fillers will not negatively impact the photocuring conversion % or the curing time to an unacceptable level.

Further, E1, E7 and E13 are embodiments of the present invention and demonstrate that the amount of component (a) may vary from 15-80 parts by weight and the amount component (b) may vary from between 85-20 parts by weigh so that the total amount of component (a) and component (b) is 100 parts by weight.

In some embodiments, the present photocurable conductive black composition comprising:
(a) 15-80 parts by weight of at least one (meth)acrylate-functionalized urethane oligomer;
(b) 85-20 parts by weight of at least one polymerizable compound;
(c) 0.1-5 parts by weight of a photoinitiator;
(d) 0.1-10 parts by weight of a visible-light blocking system; and
(e) 0.1-10 parts by weight of conductive fillers;

wherein
the total amount of component (a) and component (b) is 100 parts by weight; and
the amounts of component (c), component (d) and component (e) are based on the total amount of components (a) and (b).

TABLE 3

| Component | | E5 | E13 | E14 | E15 | E16 | E17 | E18 | E19 |
|---|---|---|---|---|---|---|---|---|---|
| A-1 | UA-1 | 50 | 50 | 50 | 50 | 50 | 50 | 50 | 50 |
| B-1 | iBOA | 30 | 30 | 30 | 30 | 20 | 20 | 20 | 20 |
| B-2 | A-DCP | 20 | 20 | 20 | 15 | 20 | 20 | 20 | 20 |
| B-3 | P-2M | | | | 5 | | | | |
| B-4 | BPE-200 | | | | | 10 | | | |
| B-5 | 9PG | | | | | | 10 | | |
| B-6 | 9G | | | | | | | 10 | |
| B-7 | TMPEOTA | | | | | | | | 10 |
| C-1 | TPO-L | 1.0 | 1.0 | 1.0 | 1.0 | 1.0 | 1.0 | 1.0 | 1.0 |
| C-2 | Omnirad 819 | 0.225 | 0.225 | 0.225 | 0.225 | 0.225 | 0.225 | 0.225 | 0.225 |
| D-2 | L-0086 | 1.0 | 2.0 | 4.0 | 4.0 | 4.0 | 4.0 | 4.0 | 4.0 |
| CF-1 | CNT | 0.7 | 0.7 | 0.7 | 0.7 | 0.7 | 0.7 | 0.7 | 0.7 |

| | | | | | | | | |
|---|---|---|---|---|---|---|---|---|
| Curing time (seconds) | 30 | 60 | 60 | 60 | 60 | 60 | 60 | 60 |
| Curing conversion, % | ⊚ | ⊚ | ⊚ | ⊚ | ⊚ | ⊚ | ⊚ | ⊚ |
| OD_{AVG} | 1.17 | 1.51 | 2.08 | 2.14 | 2.10 | 2.07 | 2.04 | 2.09 |
| OD₃₆₅ | 1.09 | 1.37 | 1.74 | 1.78 | 1.75 | 1.72 | 1.63 | 1.71 |
| OD_{AVG}/OD₃₆₅ | 1.07 | 1.10 | 1.19 | 1.20 | 1.20 | 1.21 | 1.25 | 1.22 |
| Resistivity (MΩ/sq) | ⊚ | ⊚ | ⊚ | ⊚ | ⊚ | ⊚ | ⊚ | ⊚ |

For the data in Table 3, the following is evident.

Examples E5 and E13-E19 are embodiments of the present photocurable conductive black compositions that demonstrated various polymerizable compounds may be used as component (b).

In some embodiments, the polymerizable compound of component (b) comprises a (meth)acrylate compound, a di(meth)acrylate compound, a poly(meth)acrylate compound, a di(meth)acrylate compound with functional group, or a combination thereof.

In some embodiments, the polymerizable compound of component (b) is selected from the group consisting of isobornyl (meth)acrylate, dihydrodicyclopentadienyl (meth)acrylate, dicyclopentadienyl (meth)acrylate, poly(ethylene glycol) di(meth)acrylate, poly(propylene glycol) di(meth)acrylate, glyceryl ethoxylate di(meth)acrylate, glyceryl propoxylate di(meth)acrylate, tricyclodecane dimethanol di(meth)acrylate, bisphenol A ethoxylate di(meth)acrylate, bisphenol A propoxylate di(meth)acrylate, bisphenol A ethoxylate propoxylate di(meth)acrylate, methacryloyloxyethyl phosphate, bis[2-((meth)acryloyloxy)ethyl] phosphate; trimethylolpropane tri(meth)acrylate, trimethylolpropane ethoxylate tri(meth)acrylate, trimethylolpropane propoxylate tri(meth)acrylate, tris(2-hydroxy-ethyl)isocyanurate tri(meth)acrylate, pentaerythritol ethoxylate tetra(meth)acrylate, pentaerythritol propoxylate tetra(meth)acrylate, dipentaerythritol hexa(meth)acrylate; and a combination thereof.

TABLE 4

| Component | | E19 | E20 | E21 | E22 | E23 | E24 | E25 |
|---|---|---|---|---|---|---|---|---|
| A-1 | UA-1 | 50 | 50 | | | 50 | 50 | 50 |
| A-2 | Quick cure ® | | | 50 | | | | |
| | 7100 | | | | | | | |
| A-3 | Quick cure ® | | | | 50 | | | |
| | 8100 | | | | | | | |
| B-1 | iBOA | 20 | 20 | 20 | 20 | 20 | 20 | 20 |
| B-2 | A-DCP | 20 | 20 | 20 | 20 | 20 | 20 | 20 |
| B-7 | TMPEOTA | 10 | 10 | 10 | 10 | 10 | 10 | 10 |
| C-1 | TPO-L | 1.0 | 1.0 | 1.0 | 1.0 | 1.0 | 1.0 | 6.0 |
| C-2 | Omnirad 819 | 0.225 | 0.225 | 0.225 | 0.225 | 0.225 | 0.225 | 0.225 |
| D-2 | L-0086 | 4.0 | 1.0 | 1.0 | 1.0 | 4.0 | 4.0 | 4.0 |
| CF-1 | CNT | 0.7 | 0.7 | 0.7 | 0.7 | | | |
| CF-3 | CNS | | | | | 0.3 | 0.7 | 0.7 |

| | | | | | | | |
|---|---|---|---|---|---|---|---|
| Curing time (seconds) | 60 | 30 | 30 | 30 | 60 | 60 | 30 |
| Curing conversion, % | ⊚ | ⊚ | ⊚ | ⊚ | ⊚ | ⊚ | ⊚ |
| OD_{AVG} | 2.09 | 1.13 | 1.13 | 1.16 | 1.84 | 1.95 | 1.91 |
| OD₃₆₅ | 1.71 | 1.05 | 1.03 | 1.07 | 1.51 | 1.82 | 1.82 |
| OD_{AVG}/OD₃₆₅ | 1.22 | 1.08 | 1.10 | 1.08 | 1.22 | 1.07 | 1.05 |
| Resistivity (MΩ/sq) | ⊚ | ⊚ | ⊚ | ⊚ | ⊚ | ⊚ | ⊚ |

For the data in Table 4, the following is evident.

Examples E19-E25 are embodiments of the present photocurable conductive black compositions. Examples E20-E22 demonstrated various (meth)acrylate-functionalized urethane oligomers may be used as component (a) in the present photocurable conductive black composition.

Comparison between E19 and E24, the present photocurable conductive black compositions may contain different carbon-based conductive fillers to provide desired electrical conductivity so long as the amount of the conductive fillers will not negatively impact the photocuring conversion % or the curing time to an unacceptable level.

Comparison between E24 and E25, the curing time reduced as the photoinitiator amount increase, which suggests that faster curing speed may be achieved by increasing photoinitiator concentration. While some of the embodiments of the present invention have been described in detail above, it is, however, possible for those of ordinary skill in the art to make various modifications and changes to the embodiments shown without substantially departing from the teaching and advantages of the present invention. Such modifications and changes are encompassed in the scope of the present invention as set forth in the appended claims.

What is claimed is:

1. A photocurable conductive black composition comprising:
(a) 10-90 parts by weight of at least one (meth)acrylate-functionalized urethane oligomer;
(b) 90-10 parts by weight of at least one polymerizable compound;
(c) 0.1-10 parts by weight of a photoinitiator;
(d) 0.1-10 parts by weight of a visible-light blocking system; and
(e) 0.1-10 parts by weight of conductive fillers;
wherein
the total amount of the (meth)acrylate-functionalized urethane oligomer of component (a) and the polymerizable compound of component (b) is 100 parts by weight;
the amounts of component (c), component (d) and component (e) are based on the total amount of the (meth)acrylate-functionalized urethane oligomer of component (a) and the polymerizable compound of component (b) being 100 parts by weight; and
the photocurable conductive black composition has an average optical density in the visible-light region from 400 nm to 700 nm, referred as OD_{AVG}, being 1.0 or more; an optical density at the wavelength of 365 nm, referred as OD₃₆₅, being 1.9 or less; and the optical density data are obtained by measuring a 30 μm thick cured film composed of the photocurable conductive black composition by a UV-VIS absorption spectroscopy.

2. The photocurable conductive black composition according to claim 1, wherein the ratio of OD_{AVG} to OD₃₆₅ of the photocurable conductive black composition is 1.0 or more.

3. The photocurable conductive black composition according to claim 1, wherein the (meth)acrylate-functionalized urethane oligomer of component (a) has an average (meth)acrylate functionality of two or more per molecule.

4. The photocurable conductive black composition according to claim 1, wherein the (meth)acrylate-functionalized urethane oligomer of component (a) has a viscosity in a range of 5,000 to 400,000 mPa·s at 60° C.

5. The photocurable conductive black composition according to claim 1, wherein the (meth)acrylate-functionalized urethane oligomer of component (a) has an oligomeric backbone from the reaction of at least one diisocyanate and at least one polyalkylene glycol.

6. The photocurable conductive black composition according to claim 1, wherein the polymerizable compound of component (b) comprises at least one reactive ethylenic unsaturated bond and has a molecular weight of less than 3,000.

7. The photocurable conductive black composition according to claim 1, wherein the polymerizable compound of component (b) comprises at least one (meth)acrylate functional group and has a molecular weight of less than 3,000.

8. The photocurable conductive black composition according to claim 7, wherein the polymerizable compound of component (b) comprises a (meth)acrylate compound, a di(meth)acrylate compound, a poly(meth)acrylate compound, or a combination thereof.

9. The photocurable conductive black composition according to claim 8, wherein
the (meth)acrylate compound is at least one selected from the group consisting of butyl (meth)acrylate, 2-ethylhexyl (meth)acrylate, isooctyl (meth)acrylate, 2-propylheptyl (meth)acrylate, isodecyl (meth)acrylate, lauryl (meth)acrylate, tridecyl (meth)acrylate, stearyl (meth)acrylate, behenyl (meth)acrylate, cyclohexyl (meth)acrylate, tetrahydrofurfuryl (meth)acrylate, cyclic trimethylolpropane formal (meth)acrylate, isobornyl (meth)acrylate, dicyclopentadienyl (meth)acrylate, dihydrodicyclopentadienyl (meth)acrylate, dicyclopentenyloxyethyl (meth)acrylate, benzyl (meth)acrylate, 2-phenoxyethyl (meth)acrylate, (o-phenylphenoxy)ethyl (meth)acrylate, nonylphenol (meth)acrylate, 9-anthracenyl methyl (meth)acrylate, 1-pyrenylmethyl (meth)acrylate, 2-ethoxyethyl (meth)acrylate, 2-(2-methoxyethoxy)ethyl (meth)acrylate, 2-(2-ethoxyethoxy)ethyl (meth)acrylate, triethylene glycol methyl ether (meth)acrylate, polyethylene glycol methyl ether (meth)acrylate, tripropylene glycol methyl ether (meth)acrylate, ethoxylated phenol (meth)acrylate, ethoxylated nonylphenol (meth)acrylate, ethoxylated neopentyl glycol mono(meth)acrylate, propoxylated neopentyl glycol mono(meth)acrylate, caprolactone (meth)acrylate, 2-(meth)acryloyloxyethyl succinate, 2-(acetoacetoxy)ethyl (meth)acrylate, 2-(phosphonooxy)ethyl (meth)acrylate, 3-(phosphonooxy)propyl (meth)acrylate, 2-(2-phosphonooxyethoxy)ethyl (meth)acrylate, 5-(phosphonooxy)pentyl (meth)acrylate, 6-(phosphonooxy)hexyl (meth)acrylate, 2-[(hydroxymethoxyphosphinyl)oxy]ethyl (meth)acrylate, 2-[(ethoxyhydroxyphosphinyl)oxy]ethyl (meth)acrylate, 2-[(hydroxypropoxy-phosphinyl)oxy]ethyl (meth)acrylate, and a combination thereof;
the di(meth)acrylate compound is at least one selected from the group consisting of 1,2-ethanediol di(meth)acrylate, 1,3-butanediol di(meth)acrylate, 1,4-butanediol di(meth)acrylate, 1,6-hexanediol di(meth)acrylate, 1,8-octanediol di(meth)acrylate, 1,9-nonanediol di(meth)acrylate, 1,10-decanediol di(meth)acrylate, polybutadiene di(meth)acrylate, polytetramethylene glycol di(meth)acrylate, propylene glycol di(meth)acrylate, neopentyl glycol di(meth)acrylate, diethylene glycol di(meth)acrylate, triethylene glycol di(meth)acrylate, tetraethylene glycol di(meth)acrylate, polyethylene glycol di(meth)acrylate, dipropylene glycol di(meth)acrylate, tripropylene glycol di(meth)acrylate, tetrapropylene glycol di(meth)acrylate, polypropylene glycol di(meth)acrylate, glycerol 1,3-di(meth)acrylate, ethoxylated glyceryl di(meth)acrylate, propoxylated glyceryl di(meth)acrylate, tricyclodecanedimethanol di(meth)acrylate, neopentyl glycol di(meth)acrylate, ethoxylated neopentyl glycol ethoxylate di(meth)acrylate, propoxylated neopentyl glycol di(meth)acrylate, ethoxylated bisphenol A di(meth)acrylate, propoxylated bisphenol A di(meth)acrylate, ethoxylated propoxylated bisphenol A di(meth)acrylate, methacryloyloxyethyl phosphate, bis[2-((meth)acryloyloxy)ethyl] phosphate, and a combination thereof; and
the poly(meth)acrylate compound is at least one selected from the group consisting of trimethylolpropane tri(meth)acrylate, ethoxylated trimethylolpropane tri(meth)acrylate, propoxylated trimethylolpropane tri(meth)acrylate, glycerin tri(meth)acrylate, ethoxylated glyceryl tri(meth)acrylate, propoxylated glyceryl tri(meth)acrylate, pentaerythritol tri(meth)acrylate, tris(2-hydroxyethyl) isocyanurate tri(meth)acrylate, pentaerythritol tetra(meth)acrylate, ethoxylated pentaerythritol tetra(meth)acrylate, propoxylated pentaerythritol tetra(meth)acrylate, ditrimethylolpropane tetra(meth)acrylate, ethoxylated ditrimethylolpropane tetra(meth)acrylate, propoxylated ditrimethylol-propane tetra(meth)acrylate, dipentaerythritol penta(meth)acrylate, ethoxylated dipentaerythritol penta(meth)acrylate, dipentaerythritol hexa(meth)acrylate, and a combination thereof.

10. The photocurable conductive black composition according to claim 1, wherein the photoinitiator of component (c) comprises at least one compound selected from the group consisting of 2,4,6-trimethylbenzoylethoxyphenylphosphine oxide, phenylbis(2,4,6-trimethylbenzoyl)phosphine oxide, diphenyl(2,4,6-trimethylbenzoyl) phosphine oxide, bis(2,6-di-methoxybenzoyl)(2,4,4-tri-methyl-pentyl)phosphine oxide, 2,2-diethoxyacetophenone, 2,2-dimethoxy-2-phenylacetophenone, 1-hydroxycyclohexyl phenyl ketone, 2-hydroxy-2-methylpropiophenone, 2-hydroxy-4′-(2-hydroxyethoxy)-2-methylpropiophenone, 2-benzyl-2-dimethylamino-4′-morpholinobutyrophenone, 2-methyl-4′-(methylthio)-2-morpholinopropiophenone, benzophenone, benzyl dimethyl ketal, 2-isopropylthioxanthone, and a mixture thereof.

11. The photocurable conductive black composition according to claim 1, wherein the visible-light blocking system of component (d) comprises dyes, pigments, or mixtures thereof.

12. The photocurable conductive black composition according to claim 1, wherein the conductive fillers of component (e) are in a form of particles, flakes, whiskers, tubes, or wires.

13. The photocurable conductive black composition according to claim 1, wherein the conductive fillers of component (e) comprise metallic fillers, carbon-based fillers, or combinations thereof.

14. The photocurable conductive black composition according to claim 13, wherein the conductive fillers of component (e) are metallic fillers comprising at least one metal selected from Au, Ag, Cu, and an alloy thereof; or metal-coated fillers that are surface-coated with Au, Ag, or Cu.

15. The photocurable conductive black composition according to claim 13, wherein the conductive fillers of component (e) are carbon-based fillers including carbon black, graphite, graphene, carbon hollow spheres, carbon fibers, carbon nanotubes, or combinations thereof.

16. The photocurable conductive black composition according to claim 1, wherein the photocurable conductive black composition after curing is electrically conductive and has an electrical resistivity of 0.1 MΩ/square or less.

17. The photocurable conductive black composition according to claim 1, further comprising (f) 0.1-10 parts by weight of a thermal initiator, based on the total amount of the (meth)acrylate-functionalized urethane oligomer of component (a) and the polymerizable compound of component (b) being 100 parts by weight.

18. The photocurable conductive black composition according to claim 17, wherein the thermal initiator of component (f) is an organic peroxide, an azo compound, or a combination thereof.

19. A method for forming a cured product composed of the photocurable conductive black composition of claim 1, comprising:
i) providing a substrate;
ii) applying the photocurable conductive black composition of claim 1 to the substrate;
iii) irradiating light rays in a wavelength region of from 300 nm to 400 nm by a light source to obtain a substrate having a cured product of the photocurable conductive black composition of claim 1; and
iv) optionally, heating the substrate having the cured product of step (iii);
wherein
the substrate is a component of an article; and
the article is an entertainment device, a mobile device, or an electronic device.

20. An article, comprising a cured product composed of the photocurable conductive black composition of claim 1, wherein the article is an entertainment device, a mobile device, or an electronic device.
